(19) United States
(12) Patent Application Publication
(10) Pub. No.: US 2018/0027506 A1
(43) Pub. Date: Jan. 25, 2018

(54) TECHNIQUES FOR POWER ZONING IN A NETWORK ENVIRONMENT

(71) Applicant: Zinwave Limited, Cambridge (GB)

(72) Inventors: Matthew P. Pasulka, Huntsville, AL (US); Andrew Robert Bell, Cambridge (GB)

(21) Appl. No.: 15/215,451

(22) Filed: Jul. 20, 2016

(51) Int. Cl. H04W 52/34; H04W 76/02

(52) U.S. Cl. CPC H04W 52/346; H04W 76/02; H04W 84/12

(57) ABSTRACT

Embodiments of the present invention provide techniques for power management in a network environment. A wireless networking system can include various access points in different areas of a deployment environment. Each access point may include a power manager which determines a transmission power for the access point to minimize interference with neighboring access points. The power manager can determine zones associated with each access point based on the signal strength of devices within those zones and assign each zone to a separate channel. When a request is received from a client device to access the wireless network, the client device can be assigned to a channel based on connection information associated with the client device, such as signal strength or error rate. The connection information of each client device can be monitored periodically and the client devices can be reassigned to different channels based on changes to the connection information.

### BACKGROUND

Wireless networking is an increasingly common feature provided by businesses, residential and commercial spaces, municipalities, and other areas. Wireless networks allocate finite bandwidth to client devices as they connect. For example, wireless local area networks enable many common devices, such as desktop computers, laptop computers, smartphones, digital cameras, tablet computers and digital audio players, to communicate with one another, access network resources, connect to other networks, such as the internet, etc. A wireless network may be deployed using one or more access points arranged in a deployment environment (including indoor and outdoor locations).

These networks typically operate in the ISM (industrial, scientific, and medical) radio bands along with many other devices, such as microwaves, cordless telephones, Bluetooth devices, near field communication devices, etc. As such, these bands are increasingly crowded with devices, and multiple wireless networks, leading to increased interference. Additionally, these networks are increasingly installed in user-dense environments, such as dense commercial and residential buildings, event spaces, and the like. This leads to more client devices connecting to these networks, leading to various device management and network management issues.

Embodiments of the present invention provide techniques that address these and other problems in network environments.

### SUMMARY

Embodiments of the present invention provide techniques for power management in a network environment. A wireless networking system can include various access points. These access points may each provide coverage over a different area of a deployment environment. Each access point may include a power manager which determines a transmission power for the access point to minimize interference with neighboring access points. Additionally, the power manager can determine one or more zones associated with each access point based on the signal strength of devices within those zones and assign each zone to a separate channel. When a request is received from a client device to access the wireless network, the wireless networking system can determine connection information associated with the device, such as signal strength and/or error rate. Based on the connection information, the client device can be assigned to a corresponding channel. In some embodiments, the connection information of each client device can be monitored periodically and the client devices can be reassigned to different channels based on changes to the connection information.

### BRIEF DESCRIPTION OF THE DRAWINGS

Various embodiments in accordance with the present disclosure will be described with reference to the drawings, in which:

FIG. 1 illustrates an example of a network environment, in accordance with embodiments of the present invention;

FIG. 2 illustrates an example of managing power of multiple access points, in accordance with an embodiment of the present invention;

FIG. 3 illustrates a block diagram of an access point in a network environment, in accordance with an embodiment of the present invention;

FIG. 4 illustrates a method of power management in a network environment, in accordance with an embodiment of the present invention;

FIG. 5 illustrates a high level block diagram of a computer system, in accordance with an embodiment of the present invention.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present invention provide techniques for power management in a network environment. A wireless networking system can include various access points. These access points may each provide coverage over a different area of a deployment environment. Each access point may include a power manager which determines a transmission power for the access point to minimize interference with neighboring access points. Additionally, the power manager can determine one or more zones associated with each access point based on the signal strength of devices within those zones and assign each zone to a separate channel. When a request is received from a client device to access the wireless network, the wireless networking system can determine connection information associated with the device, such as signal strength and/or error rate. Based on the connection information, the client device can be assigned to a corresponding channel. In some embodiments, the connection information of each client device can be monitored periodically and the client devices can be reassigned to different channels based on changes to the connection information.

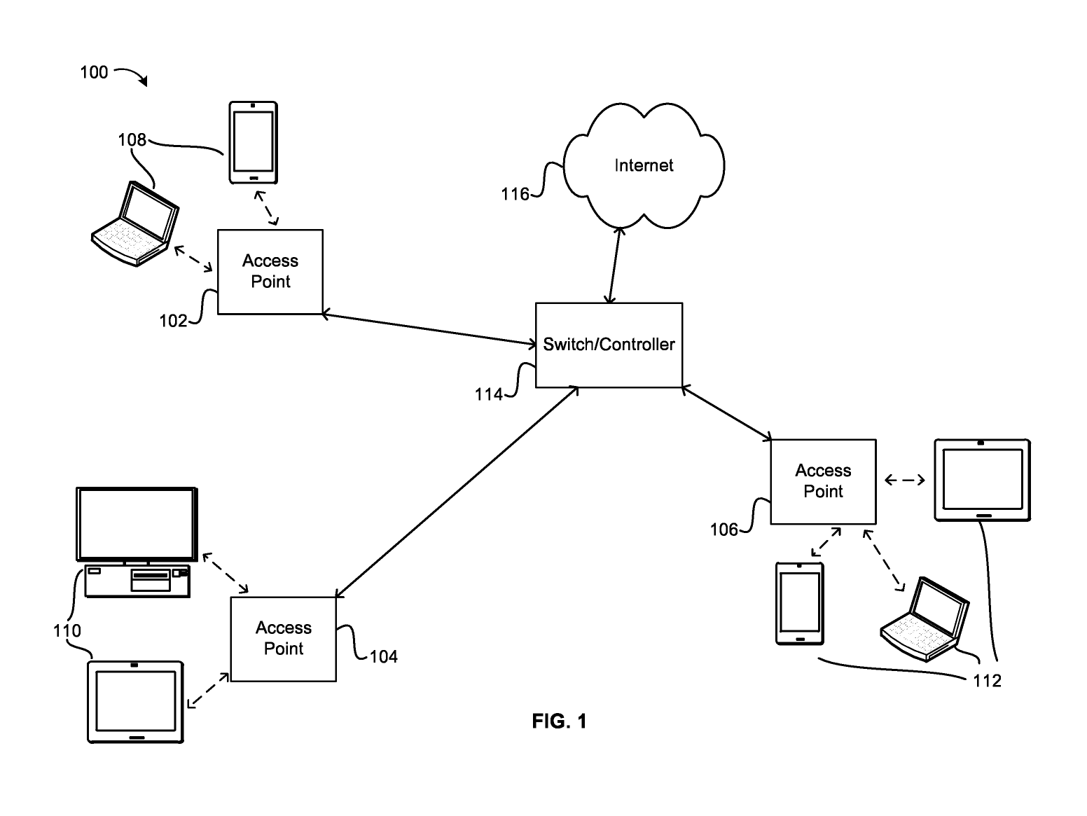

FIG. 1 illustrates an example of a network environment 100, in accordance with embodiments of the present invention. As shown in FIG. 1, a wireless networking system can include one or more wireless access points 102, 104, 106 which connect various client devices 108, 110, 112. In various embodiments, client devices may include personal computers, cell phones, handheld messaging devices, laptop computers, set-top boxes, personal data assistants, and any other suitable devices configured to send and receive information over a network. Although embodiments of the present invention are described herein with respect to a wireless local area network (WLAN) implemented using devices that support the IEEE 802.11 family of specifications, the wireless networking system can support any appropriate wireless network, including an intranet, the Internet, a cellular network, a local area network, or any other such network or combination thereof. Components used for such a system can depend at least in part upon the type of network and/or environment selected. Protocols and components for communicating via such a network are well known and will not be discussed herein in detail.

A given access point can communicate with multiple client devices within range of the access point in the deployment environment. The range of any given access point may vary depending on the placement of the access point within the deployment environment (e.g., indoor/outdoor placement, height, local physical obstructions, etc.), antenna type, power output, and local interference (e.g., from other devices operating in the same frequency range).

In the example shown in FIG. 1, switch/controller 114 connects the access points 102, 104, 106 to the internet 116. Switch/controller 114 may connect the access points to various network resources, such as a wired LAN, one or more local or remote servers, data stores, and other resources. In some embodiments, switch/controller 114 can manage more or fewer access points than are shown in FIG. 1. Additionally, multiple switches may be used to connect other access points to a LAN or other network resource. As discussed further below, power management can be performed by each access point 102, 104, 106, by switch/controller 114, or by a combination of devices. Such management functions can include power adjustments, device connection management, channel management, and security management (e.g., authentication, authorization, etc.).

For example, switch/controller 114 may provide authentication and authorization services for requests received to access the wireless network. In some embodiments, switch/controller 114 may connect to one or more servers to perform authentication and authorization, which may use information stored in one or more data stores to generate a login page to be displayed on the client device, through which account credentials (e.g., username and password) may be provided. In some embodiments, information may be served to the client devices using HyperText Markup Language (“HTML”), Extensible Markup Language (“XML”), or another appropriate structured language. In various embodiments, data stores may refer to a device or combination of devices configured to store, access, and retrieve data. Such devices may include data servers, databases, data storage devices, data storage media, or any combination thereof. In various embodiments, data stores may be deployed individually, or as a distributed or clustered system.

As discussed further below, as more client devices connect to an access point, the client devices can be assigned to different channels. As more devices connect, devices will share time on the same channel. Devices connected to the same channel each communicate with the access point in turn, with one device transmitting at a given time and other devices deferring communication. Different client devices implementing different versions of the 802.11 specification may connect to the same wireless network. However, as the specification has evolved, the timing parameters have changed. To be backwards compatible, a wireless network implementing an 802.11 standard uses the timing parameters associated with the slowest connected device for a given channel. This slows the connection speed of every client device connected to that channel. As such, improved connection management is needed to improve the performance of the wireless network and connected client devices.

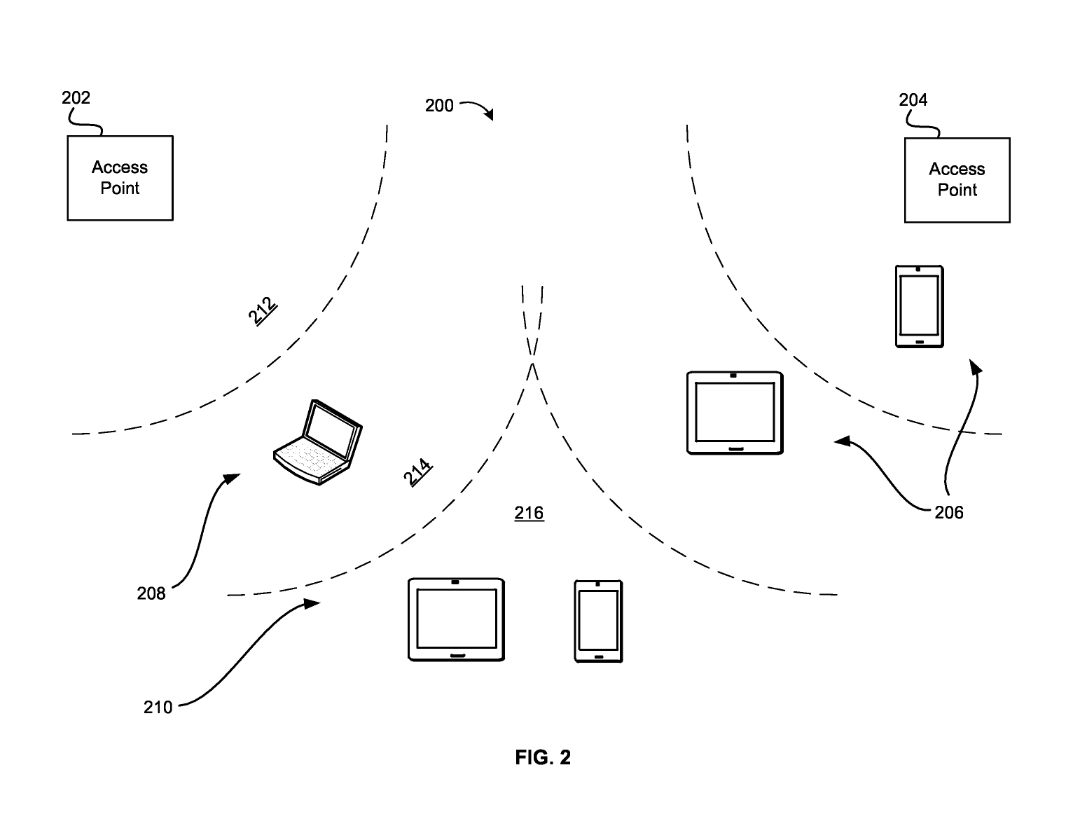

FIG. 2 illustrates an example 200 of managing power of multiple access points, in accordance with an embodiment of the present invention. Wireless networking systems, such as that described above with respect to FIG. 1, may include multiple access points deployed at different locations to increase network coverage and reduce interference. Deployment locations may be selected based on environmental conditions within the deployment area. For example, a wireless networking system that provides a wireless network in outdoor and indoor spaces may include access points that are deployed indoors, to protect the access points from weather conditions that may adversely affect the lifespan and functioning of the access points. Similarly, access points may be deployed to locations where physical access to the access points is limited, to avoid potential damage to the access points.

As shown in FIG. 2, each access point 202, 204 may service various client devices 206, 208, 210 within the deployment area. As shown in FIG. 2, access points 202 and 204 may provide wireless network coverage accessible to the client devices in various locations within the deployment area. As such, there is potential for interference between the access points as well as from other nearby devices operating in the same frequency range, physical barriers, and the like. This may reduce the signal to noise ratio (SNR) resulting in reduced range and increased error rates. Depending on the locations of the client devices, the transmission power level of each access point can be adjusted to improve coverage. For example, client devices at zone 212, closest to access point 202, may have the highest power signals, with lower interference, while client device 208, and similarly located client devices, in zone 214 farther from access point 202 may have lower power signals and/or more interference due to intervening devices and physical barriers, leading to higher error rates. Client devices 210 in zone 216, may have still lower power signals. As shown in FIG. 2, this results in roughly concentric zones around each access point corresponding to different signal strengths. Variations within and across zones may occur depending on environmental conditions, physical obstacles, and other devices and wireless networks operating within the same frequency bands as access point 202. In some embodiments, each zone may be defined by a range of signal strength (e.g., received power levels by the access point from client devices) and assigned a different channel. When a device connects to the access point, the device can be assigned a channel based on the device's signal strength. In some embodiments, as a client device's signal strength varies, the client device can be reassigned to a channel associated with that signal strength.

In various embodiments, switch/controller 114 can manage the transmission power of access points 202, 204 to minimize interference between the access points and to achieve particular performance characteristics, such as range, data rate, or other performance characteristics of the wireless network. By increasing the transmission power, the SNR at more distant client devices 204, 206 to increase, improving communication with these client devices. However, increasing the transmission power of each access point may also increase interference levels caused by overlapping coverage of the access points. By regulating the transmission power of each access point, the system can create a plurality of wireless network zones while minimizing overlap. In some embodiments, each zone may be assigned a different channel by the access points. For example, in the embodiment shown in FIG. 2, the range of access point 202 and access point 204 overlaps at the location of devices 210. Each access point 202, 204 may detect the presence of the other access point, for example through direct communication between the access points and/or through detection of interference (e.g., using a spectrum analyzer). As such, one or both of access points 202 and 204 can reduce their transmission power to minimize overlap.

In some embodiments, device management across available channels of the wireless network can be performed to improve network performance. Channels can be defined within the frequency bands used by the wireless networking system according to the type of wireless network being provided. For example, 802.11 wireless networks include 11 channels in the 2.4 GHz frequency band, which are spread across the frequency band. This results in three non-overlapping channels (e.g., channels 1, 6, and 11). Channel management can improve network performance by, e.g., avoiding interference that is specific to portions of the frequency band. For example, access point 202 can assign channel 1 to its wireless network zone, and access point 204 can assign channel 11 to its wireless network zone. By using non-overlapping channels and adjusting transmission power to minimize overlapping coverage areas, interference between the access points can be reduced, improving performance of the wireless network. More or fewer channels may be available depending on the operating frequency band and local regulations.

In some embodiments, an access point can manage client devices across available channels to improve network performance. For example, client devices implementing older and slower communication standards (e.g., 802.11b versus 802.11g, 802.11ac, etc.) may be assigned to one channel, while client devices implementing newer and fast communication standards may be assigned to a different channel. Because each device assigned to a particular channel communicates in turn, slower communicating client devices also slow communication of other devices connected to that channel. For example, a faster device may be delayed in communicating with the access point 202 while the access point is communicating with a slower device. Additionally, some channels overlap within the operating frequency band. Slower devices connected to one channel may also reduce the performance of devices connected to overlapping channels. Further, client devices that connect to an access point toward the edge of that access point's range may experience a lower signal to noise ratio, which can lead to a higher error rate. A higher error rate leads to increased transmission times as data is sent repeatedly, this occupies the channel for longer periods of time and slows down other devices connected to the same channel on that access point. As such, various connection and channel policies may be used to manage transmission power levels of access points and device connections based on received power levels across access points and available channels of the wireless networking system to improve the performance of the wireless network. For example, devices with lower signal strength may be assigned to one channel, while devices with higher signal strength may be assigned to a different channel.

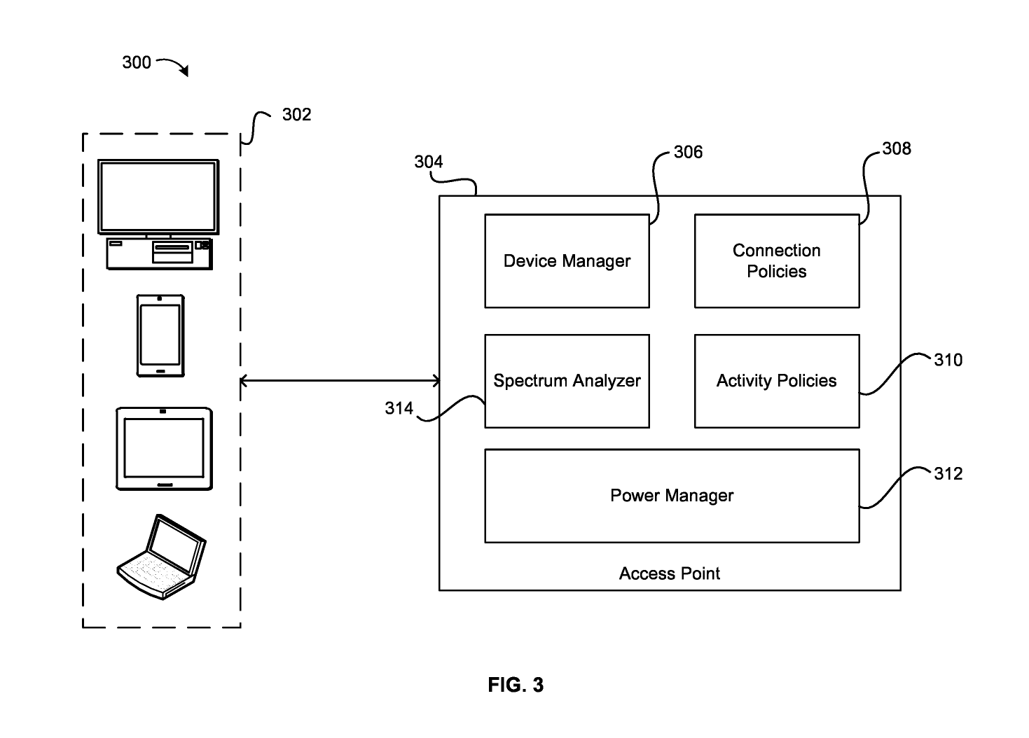

FIG. 3 illustrates a block diagram of an access point in a network environment 300, in accordance with an embodiment of the present invention. As discussed above, one or more clients 302 can access a wireless network through an access point 304. Although the embodiment shown in FIG. 3 includes an access point 304 configured to manage the client devices 302 connected thereto, in some embodiments, all or portions of this management functionality may be embodied in a controller, such as switch/controller 114, a wireless LAN controller, or other suitable controller, configured to manage multiple access points.

As shown in FIG. 3, access point 304 can include a device manager 306. When a client device requests to connect to access point 304, device manager 306 can determine client device information and connection information. For example, device manager 306 can receive a device identifier associated with the request. In some embodiments, device manager 306 can control access to the wireless network, for example by comparing the device identifier with a whitelist and/or blacklist of device identifiers. Additionally, or alternatively, device manager 306 can receive credential information, such as a username and password, from the client device and provide authentication and/or authorization services. In some embodiments, device manager 306 can send the credential information to an authentication and/or authorization server and receive an authentication and/or authorization decision. Device manager 306 can maintain a history of connected device identifiers and authentication and/or authorization decisions. In some embodiments, device manager 306 can determine a signal strength associated with the client device. The signal strength can correspond to the received power level by the access point from the client device. As discussed above, received power level may correspond generally to a distance of the client device from the access point; client devices closer to the access point will generally be associated with higher received power levels and client devices farther from the access point will generally be associated with lower received power levels.

In some embodiments, access point 304 can include one or more connection policies 308. Connection policies may define one or more performance thresholds for devices to connect to particular channels. For example, connection policies 308 can define performance thresholds for a fast channel, a medium channel, and a slow channel, where each threshold is associated with a range of power levels. In some embodiments, the thresholds may be dynamically determined based on e.g., the current power levels of client devices connected to the access point, interference, or other network and/or environmental conditions. For example, an average power level of client devices connected to a channel may be set as the threshold for that channel. In some embodiments, thresholds may be defined based on quality of service (QoS) parameters. For example, thresholds may be set to ensure at least one channel that provides a minimum transfer speed based on the QoS parameters, where higher power levels are generally associated with higher signal to noise ratios and higher transfer speeds.

In some embodiments, connection policies 308 can define error rates which when detected by access point 304 may trigger the assignment of a client device to a slower channel. For example, a connection policy may define a number of times an error rate may be determined to be above a threshold error rate before the client device is reassigned to the slower channel. Similarly, connection policies may also define conditions which can be used to determine when a client device can be reassigned to a faster channel. For example, if the error rate falls below a threshold error rate within a threshold period of time. Additionally, or alternatively, a connection policy may define a timeout period during which a client device cannot be reassigned to a faster channel after being relegated to a slower channel. In some embodiments, a connection policy may define that a client device be reconnected to a faster channel after being relegated to a slower channel, only upon beginning a new session (e.g., disconnecting from the network and reconnecting or logging-in and logging-out).

As shown in FIG. 3, access point 304 may include one or more activity policies 310. The activity policies may define particular types of traffic that are limited to particular channels and/or particular power levels. For example, client devices with the highest signal strength may correspond to those users closest to an access point. These users may more valued to the entity provided the network than users farther from the access point, as such high bandwidth activities such as video streaming, may be reserved for these users.

In some embodiments, power manager 312 can determine a power level (e.g., signal strength) associated with a client device, and assign the client device to a corresponding channel when the client device connects to the access point and/or may reassign connected client devices to channels based on connection policies 308. For example, in some embodiments, the signal strength associated with a client device may be compared to thresholds defined in connection policies 308, and the client device may be assigned to a channel corresponding to the matching thresholds. In some embodiments, connection policies 308 may define a periodic signal strength check that determines at define intervals the current signal strength of a client device. For example, as a client device moves about in the deployment environment, the signal strength associated with the client device may change. The connection policies may include a predefined number of consecutive and/or nonconsecutive periods during which the signal strength is below a threshold value before the client device is reassigned to a different channel. In some embodiments, an error rate associated with the client device can be compared to thresholds defined in connection policies 308 and the client device may be reassigned to a channel based on the error rate.

In some embodiments, power manager 312 can determine interference levels using spectrum analyzer 314. As discussed above, interference sources may include other access points, cordless phones, microwaves, and other devices operating on the ISM frequency bands shared by the wireless network. Power manager 312 may assign channels to power zones based on the detected interference. For example, a channel having the highest amount of interference may be assigned as the “slow” channel, similarly a channel having the lowest amount of interference may be assigned as the “fast” channel. In some embodiments, spectrum analyzer 314 may periodically scan for interference and power manager 312 may update the channel assignments based on changing interference levels. In some embodiments, if spectrum analyzer 314 detects interference from another access point associated with the same wireless network, power manager 312 may adjust the transmission power of the access point 304 to reduce interference. In some embodiments, power manager 312 may communicate with the interfering access point detected by spectrum analyzer 314 to request the interfering access point adjust its transmission power to reduce interference.

In some embodiments, one or more device queues may be maintained associated with each channel. Devices in the one or more device queues may be given priority to connect to the associated channel when access to the channel becomes available. When a new device attempts to connect to a channel that is full, the new device can instead be connected to an open, though potentially slower channel. The new device can also be added to a queue associated with the faster channel. As client devices disconnect from the faster channel, devices may be connected to the faster channel from the queue. Similarly, if a client device is selected to be dropped from the faster channel to due to reduced performance of the client device, that client device may be added to the queue associated with the faster channel. This way the signal strength, error rate, or other connection information of a client device that is dropped may be monitored and allowed to rejoin the faster channel based on the connection policies and the performance of the client device.

As discussed above, in some embodiments client devices may be dropped from one channel and added to a different channel. To minimize service disruption for the reassigned client device, the client may be handed-off between channels based on the type of activity the user is engaged in. For example, a user who is browsing websites may be disconnected from their current channel when a page has finished loading and connected to a new channel. This way, the period during which the user is not connected is limited to the time during which the user is consuming content that has already loaded. Similarly, a user making a voice call may not be disconnected until the call has completed, to avoid potential service disruptions. In some embodiments, where nearby access points are available, the client device may be connected to the appropriate channel at a new access point before being disconnected from the current channel at the current access point. As discussed above, the user may be added to a queue associated with the channel and access point from which they were disconnected, enabling the user to be reconnected when the channel again becomes available.

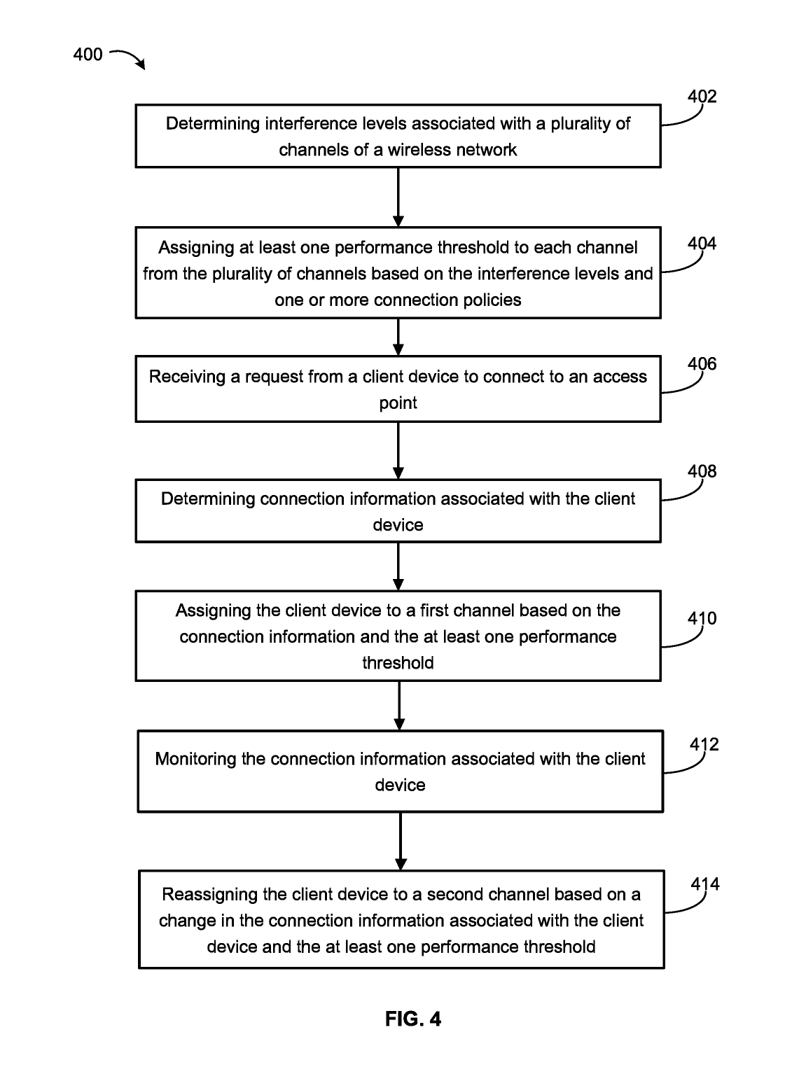

FIG. 4 illustrates a method 400 of power management in a network environment, in accordance with an embodiment of the present invention. As discussed above, as client devices connect to a wireless network, the client devices can be assigned to channels based on signal strength to improve network performance. Although in the described embodiments, power management is performed by the access point, such management may be performed by a controller that manages multiple access points.

At 402, interference levels associated with a plurality of channels of a wireless network can be determined. As discussed above, various interference sources (e.g., other access points and devices operating in the same frequency range as the wireless network) can interfere with the wireless network. Interference can reduce the range and the performance of the wireless network over one or more channels. In some embodiments, the transmission power of the access point may be adjusted based on the interference levels.

At 404, at least one performance threshold can be assigned to each channel from the plurality of channels based on the interference levels and one or more connection policies. Depending on the spectrum of the interference, some channels may experience greater interference than others. As such, a channel with more interference, which therefore generally provides poorer performance, may be determined to be a “slow” channel and assigned a performance threshold that causes slower client devices to be connected to that channel. Similarly, a channel with less interference may be assigned a performance threshold that causes faster client devices to be connected to that channel. As discussed, the performance thresholds can include at least one of a range of power levels or a range of error rates.

At 406, a request can be received from a client device to connect to an access point. As discussed above, client devices can connect to a wireless network through an access point. The access point may manage multiple client devices. In some embodiments, an access point may include one or more transceivers configured to communicate over one or more frequency bands which may be divided into a plurality of channels depending on the type of wireless network being provided.

At 408, connection information associated with the client device can be determined. The connection information can include signal strength or an error rate associated with the client device. At 410, the client device can be assigned to a first channel based on the connection information and the at least one performance threshold. In some embodiments, connection policies can define performance thresholds associated with a plurality of channels. For example, each channel may be associated with a range of power levels or error rates. As discussed above, the performance of a channel may be limited by the slowest performing client device connected to that channel which may correspond to the client device with the lowest signal strength. As such, the connection policies enable the access points to improve the performance of the wireless networks by grouping similarly performing client devices into the same channel.

At 412, the connection information associated with the client device can be monitored. Monitoring the connection information can include periodically determining the connection information associated with the client device (e.g., checking the signal strength and/or error rate of the client device at predefined intervals). Monitoring may also include determining a number of consecutive periods during which the connection information is below the at least one performance threshold. In some embodiments, the connection policies may define how many periods a client device must underperform before the client device is reassigned to a slower channel.

At 414, the client device can be reassigned to a second channel based on a change in the connection information associated with the client device and the at least one performance threshold. In some embodiments, after a threshold amount of time has elapsed since the client device was reassigned from the first channel to the second channel, the connection information for the client device can be monitored. If it is determined that the connection information is above the performance threshold for a number of consecutive periods, then the client device may be reassigned from the second channel to the first channel. This way when client device performance improves, it can be returned to a faster channel. In some embodiments, the client device may be reassigned between channels at a time determined based on a type of activity associated with the client device.

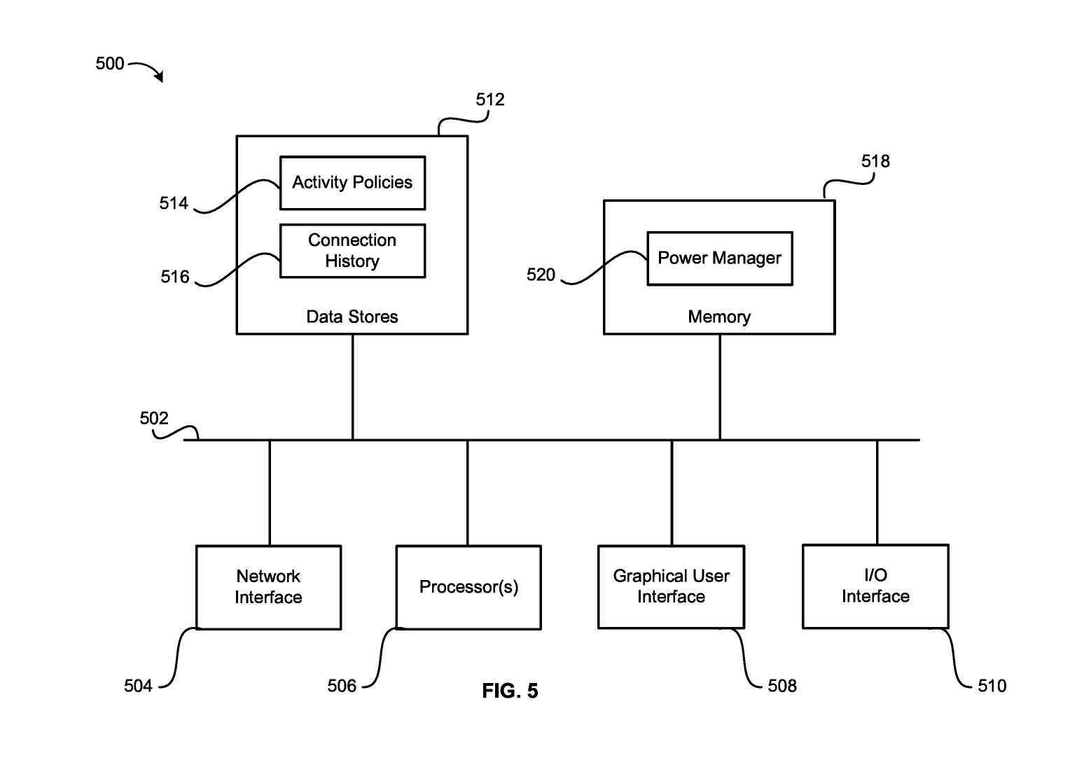

FIG. 5 illustrates a high level block diagram of a computer system 500, in accordance with an embodiment of the present invention. As shown in FIG. 5, a computer system can include hardware elements connected via a bus 502, including a network interface 504, that enables the computer system to connect to other computer systems over a wireless local area network (WLAN), wide area network (WAN), mobile network (e.g., EDGE, 3G, 4G, or other mobile network), or other network. Network interface 504 can further include a wired or wireless interface for connecting to infrared, Bluetooth, or other wireless devices, such as other client devices, network resources, or other wireless capable devices. The computer system can further include one or more processors 506, such as a central processing unit (CPU), field programmable gate array (FPGA), application-specific integrated circuit (ASIC), network processor, or other processor. Processers may include single or multi-core processors.

In some embodiments, the computer system can include a graphical user interface (GUI) 508. GUI 508 can connect to a display (LED, LCD, tablet, touch screen, or other display) to output user viewable data. In some embodiments, GUI 508 can be configured to receive instructions (e.g., through a touch screen or other interactive interface). In some embodiments, I/O interface 510 can include various interfaces for user input devices including keyboards, mice, or other user input devices.

In some embodiments, the computer system may include local or remote data stores 512. Data stores 512 can include various computer readable storage media, storage systems, and storage services, as are known in the art (e.g., disk drives, CD-ROM, digital versatile disk (DVD) or other optical storage, magnetic cassettes, magnetic tape, magnetic disk storage or other magnetic storage devices, relational databases, object storage systems, local or cloud-based storage services, or any other storage medium, system, or service). Data stores 510 can include data generated, stored, or otherwise utilized as described herein. For example, data stores 510 can include all or portions of activity policies 514 as well as performance thresholds, connection policies, and other data. Data stores 512 may also include connection history 516 and other client device data, generated and stored as described above. Memory 518 can include various memory technologies, including RAM, ROM, EEPROM, flash memory or other memory technology. Memory 518 can include executable code to implement methods as described herein, such as power manager 520.

A computing device typically will include an operating system that provides executable program instructions for the general administration and operation of that computing device and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 5. Thus, the depiction of the system 500 in FIG. 5 should be taken as being illustrative in nature and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method, comprising:
determining interference levels associated with a plurality of channels of a wireless network;
assigning at least one performance threshold to each channel from the plurality of channels based on the interference levels and one or more connection policies;
receiving a request from a client device to connect to an access point;
determining connection information associated with the client device;
assigning the client device to a first channel based on the connection information and the at least one performance threshold;
monitoring the connection information associated with the client device; and
reassigning the client device to a second channel based on a change in the connection information associated with the client device and the at least one performance threshold.

2. The method of claim 1, wherein the connection information includes at least one of a signal strength or an error rate associated with the client device.

3. The method of claim 1, wherein the at least one performance threshold includes at least one of a range of power levels or a range of error rates.

4. The method of claim 1, wherein monitoring the connection information associated with the client device further comprises:
periodically determining the connection information associated with the client device; and
determining a number of consecutive periods during which the connection information is below the at least one performance threshold.

5. The method of claim 4, further comprising:
determining a threshold amount of time has elapsed since the client device was reassigned from the first channel to the second channel;
determining a number of consecutive periods during which the connection information is above the at least one performance threshold; and
reassigning the client device from the second channel to the first channel.

6. The method of claim 5, wherein the client device is reassigned to the second channel at a time determined based on a type of activity associated with the client device.

7. The method of claim 1, further comprising:
adjusting a transmission power of the access point based on the interference levels.

8. A wireless networking system comprising:
at least one access point, include a computer readable medium and processor, the at least one access point configured to:
determine interference levels associated with a plurality of channels of a wireless network;
assign at least one performance threshold to each channel from the plurality of channels based on the interference levels and one or more connection policies;
receive a request from a client device to connect to an access point;
determine connection information associated with the client device;
assign the client device to a first channel based on the connection information and the at least one performance threshold;
monitor the connection information associated with the client device; and
reassign the client device to a second channel based on a change in the connection information associated with the client device and the at least one performance threshold.

9. The wireless networking system of claim 8, wherein the connection information includes at least one of a signal strength or an error rate associated with the client device.

10. The wireless networking system of claim 8, wherein the at least one performance threshold includes at least one of a range of power levels or a range of error rates.

11. The wireless networking system of claim 8, wherein monitoring the connection information associated with the client device further comprises:
periodically determining the connection information associated with the client device; and
determining a number of consecutive periods during which the connection information is below the at least one performance threshold.

12. The wireless networking system of claim 11, wherein the access point is further configured to:
determine a threshold amount of time has elapsed since the client device was reassigned from the first channel to the second channel;
determine a number of consecutive periods during which the connection information is above the at least one performance threshold; and
reassign the client device from the second channel to the first channel.

13. The wireless networking system of claim 12, wherein the client device is reassigned to the second channel at a time determined based on a type of activity associated with the client device.

14. The wireless networking system of claim 8, further comprising:
adjusting a transmission power of the access point based on the interference levels.

15. A non-transitory computer readable storage medium including instructions stored thereon which, when executed by a processor, cause the processor to:
determine interference levels associated with a plurality of channels of a wireless network;
assign at least one performance threshold to each channel from the plurality of channels based on the interference levels and one or more connection policies;
receive a request from a client device to connect to an access point;
determine connection information associated with the client device;
assign the client device to a first channel based on the connection information and the at least one performance threshold;
monitor the connection information associated with the client device; and
reassign the client device to a second channel based on a change in the connection information associated with the client device and the at least one performance threshold.

16. The non-transitory computer readable storage medium of claim 15, wherein the connection information includes at least one of a signal strength or an error rate associated with the client device.

17. The non-transitory computer readable storage medium of claim 15, wherein the at least one performance threshold includes at least one of a range of power levels or a range of error rates.

18. The non-transitory computer readable storage medium of claim 15, wherein monitoring the connection information associated with the client device further comprises:
periodically determining the connection information associated with the client device; and
determining a number of consecutive periods during which the connection information is below the at least one performance threshold.

19. The non-transitory computer readable storage medium of claim 18, wherein the access point is further configured to:
determine a threshold amount of time has elapsed since the client device was reassigned from the first channel to the second channel;
determine a number of consecutive periods during which the connection information is above the at least one performance threshold; and
reassign the client device from the second channel to the first channel.

20. The non-transitory computer readable storage medium of claim 19 wherein the client device is reassigned to the second channel at a time determined based on a type of activity associated with the client device.
